(19) United States
(12) Patent Application Publication
(10) Pub. No.: US 2026/0027880 A1
(43) Pub. Date: Jan. 29, 2026

(54) TWO SPEED GEAR REDUCER ELECTRIC DRIVE MODULE

(71) Applicant: FCA US LLC, Auburn Hills, MI (US)

(72) Inventor: Thomas E. Braford, JR., Auburn Hills, MI (US)

(21) Appl. No.: 18/785,696

(22) Filed: Jul. 26, 2024

(51) Int. Cl. B60K 1/00; B60K 17/06

(52) U.S. Cl. CPC B60K 1/00; B60K 17/06; B60K 2001/001

(57) ABSTRACT

An electric drive module (EDM) for an electrified vehicle is provided. The EDM includes a housing; an electric motor; a single planetary gear set having first and second sun gears, a single planetary carrier rotationally supporting first and second planetary gears in engagement with the respective sun gears, and an absence of a ring gear; and first and second torque transfer devices (TTDs). An output of the motor is connected to the first sun gear and the carrier is connected to a final drive gearset. The EDM is selectively switchable among (i) a first gear where the first TTD is disengaged and the second TTD is engaged grounding the second sun gear to the housing, and (ii) a second gear where the second TTD is disengaged and the first TTD is engaged to couple for common rotation the carrier and the second sun gear.

### FIELD

The present application generally relates to electric drive modules for electric vehicles and, more particularly, to a two-speed electric drive module for an electrified vehicle.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Electric vehicles typically have single speed gearboxes, which while providing great torque capability on the road, are unable to provide sustained high torque for trail and sand driving or various other speeds. Such gearboxes may provide sustained high torque through higher ratio gearing, but this may not be ideal for meeting range and performance requirements for on-road and off-road usage. Moreover, such gearboxes often have relatively complex gearing arrangements and increased packaging constraints. Accordingly, while such conventional gearing systems do work for their intended purpose, there exists an opportunity for improvement in the relevant art.

### SUMMARY

According to one example aspect of the invention, an electric drive module (EDM) is provided for an electrified vehicle and includes a housing, an electric motor and a two-speed gearbox. In one exemplary implementation, the two-speed gearbox assembly incudes: a single planetary gear set having first and second sun gears, a single planetary carrier having first and second planetary gears in meshing engagement with the respective first and second sun gears, and an absence of a ring or annulus gear; a first torque transfer device configured to be controlled to selectively couple the carrier to the second sun gear; and a second torque transfer device fixed to the housing and configured for selective coupling the second sun gear to the housing. An output of the electric motor is connected to the first sun gear and the carrier is connected to a final drive gearset which is adapted to be coupled to a driveline of the vehicle. The EDM is selectively switchable among (i) a first gear where the first torque transfer device is disengaged and the second torque transfer device is engaged grounding the second sun gear to the housing; and (ii) a second gear where the second torque transfer device is disengaged and the first torque transfer device is engaged to couple for common rotation the carrier and the second sun gear.

According to one example aspect of the invention, an electrified vehicle having an electric drive module (EDM) is provided. In one exemplary implementation, the EDM incudes a housing, an electric motor and a two-speed gearbox assembly. The two-speed gearbox assembly includes: a single planetary gear set having first and second sun gears, a single planetary carrier having first and second planetary gears in meshing engagement with the respective first and second sun gears, and an absence of a ring or annulus gear; a first torque transfer device configured to be controlled to selectively couple the carrier to the second sun gear; and a second torque transfer device fixed to the housing and configured for selective coupling the second sun gear to the housing. An output of the electric motor is connected to the first sun gear and the carrier is connected to a final drive gearset which is adapted to be coupled to a driveline of the vehicle. The EDM is selectively switchable among (i) a first gear where the first torque transfer device is disengaged and the second torque transfer device is engaged grounding the second sun gear to the housing; and (ii) a second gear where the second torque transfer device is disengaged and the first torque transfer device is engaged to couple for common rotation the carrier and the second sun gear.

In some implementations, the EDM is selectively switchable to a neutral state by controlling the first and second torque transfer devices to be disengaged or open.

In some implementations, the first torque transfer device is a clutch and the second torque transfer device is a brake.

In some implementations, the two-speed gearbox assembly comprises only one planetary gearset and only two torque transfer devices.

In some implementations, the two-speed gearbox assembly further comprises an actuator for actuating both the first and second torque transfer devices. In some implementations, the EDM includes only one actuator for controlling both torque transfer devices.

In some implementations, the final drive gearset comprises an input gear coupled to the carrier and an output gear adapted to be coupled to the driveline of the vehicle. In some implementations, the final drive gearset further comprises a second gear in meshing engagement with the input gear and coupled via a first layshaft to a third gear, which is in meshing engagement with a fourth gear, which is coupled to a second layshaft forming an output of the final drive gearset. In some implementations, the output of the final drive gearset forms an input to a differential of the driveline of the vehicle. In some implementations, the first and second layshafts have parallel longitudinal rotational axes.

Further areas of applicability of the teachings of the present application will become apparent from the detailed description, claims and the drawings provided hereinafter, wherein like reference numerals refer to like features throughout the several views of the drawings. The claims form an integral part of the disclosure. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

The present disclosure will become more fully understood from the detailed description and the accompanying drawings, given purely by way of non-limiting example, wherein:

FIG. 1 is a schematic illustration of an example electric vehicle powertrain having a driveline/differential and an electric drive module with a two-speed gearbox assembly, in accordance with the principles of the present application;

FIG. 2 is a schematic diagram of one example configuration of the two-speed gearbox assembly shown in FIG. 1, in accordance with the principles of the present application;

FIG. 3 is a schematic diagram of one example operating mode of the electric drive module two-speed gearbox assembly shown in FIGS. 1 and 2, in accordance with the principles of the present application; and

FIG. 4 is a schematic diagram of one example operating mode of the electric drive module two-speed gearbox assembly shown in FIGS. 1 and 2, in accordance with the principles of the present application.

### DESCRIPTION

As previously discussed, an electrified vehicle that utilizes a single speed gearbox in or associated with an electric drive module (EDM) can include drawbacks such as reduced efficiency, and an inability to meet desired gradeability requirements and/or desired vehicle top speed requirements. Accordingly, an improved EDM for an electrified vehicle is provided. In one example, such an improved EDM includes a two-speed gearbox. In one example, this two-speed gear box includes a single planetary gearset, two torque transfer devices and a single actuator associated therewith. In one example implementation, the single planetary gearset includes two sun gears, a single carrier rotationally supporting two planetary gearsets, and an absence of any ring or annulus gear. These features alone or in combination provide for a more efficient gearbox with improved NVH that can switch between the two gears and neutral via a single actuator all while being more compact due in part to the absence of the ring gear.

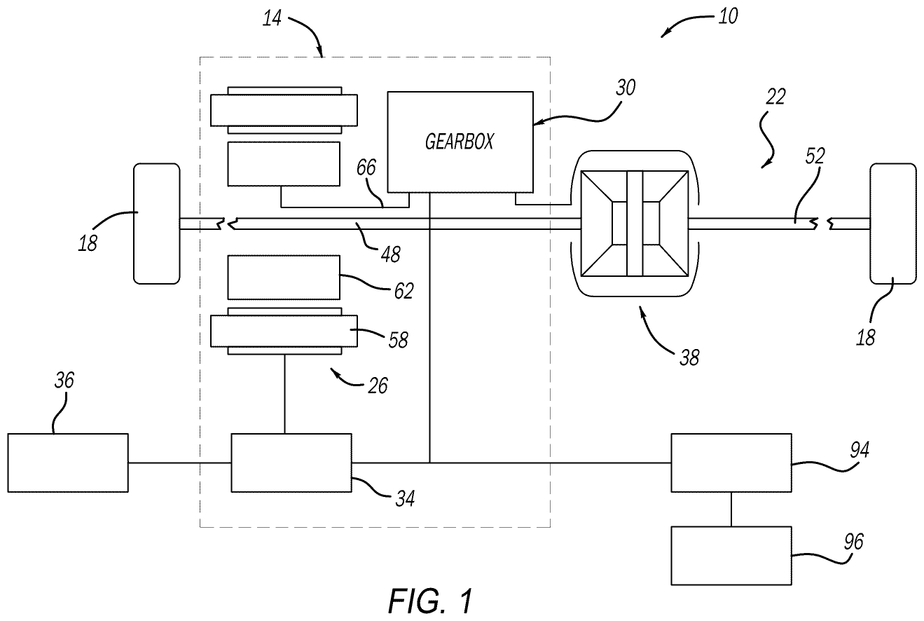

With initial reference to FIG. 1, a vehicle 10 is partially shown in accordance with the principles of the present disclosure. In the example implementation illustrated, vehicle 10 includes an electric drive module (EDM) 14 configured to generate and transfer drive torque to wheels 18 via an axle or one or more driveshafts or a driveline 22 for vehicle propulsion. The EDM 14 generally includes one or more electric drive units or motors 26 (e.g., electric traction motors), an electric drive gearbox assembly 30, and power electronics including a power inverter module (PIM) 34. The electric motor 26 is selectively connectable via the PIM 34 to a high voltage battery system 36 for powering at least the electric motor 26. The gearbox assembly 30 is configured to transfer the generated drive torque to the driveline 22 and can include a differential or the like 38 housed within a housing 42 of the EDM 14. In one example implementation, the differential 38 can be external to the EDM housing 42 and separately incorporated into or with the driveline 22. Differential 38 can take the form of various types of differentials including an open differential or a locking differential such as an electrically or mechanically locking differential. The driveline 22 can include, such as in the example illustrated, a first or left axle shaft 48 and a second or right axle shaft 52. In the example shown, the EDM 14 is configured for use on a rear axle of a two-wheel drive vehicle. It is appreciated, however, that the EDM 14 can be alternatively configured for use on a front axle of a two-wheel drive vehicle. In other examples the EDM 14 can be provided on both of the front and rear axles for a four-wheel drive or all-wheel drive vehicle configuration.

In the example implementation illustrated, the electric motor 26 generally includes a stator 58, a rotor 62, and a rotor output shaft 66. The stator 58 is fixed (e.g., to housing 42) and the rotor 62 is configured to rotate relative to the stator 58 to drive the rotor shaft 66 and thus ultimately the vehicle axles 48, 52 (e.g., half shafts) and therefore drive wheels 18.

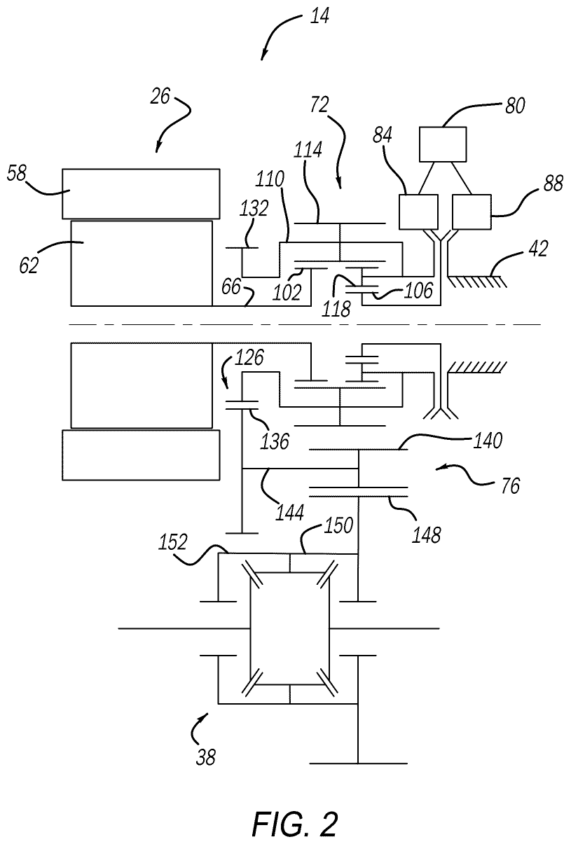

With reference now to FIG. 2 and continuing reference to FIG. 1, the two-speed gearbox assembly 30 will be described in greater detail. In the example implementation, the gearbox assembly 30 is coupled to the electric motor 26 through the rotor output shaft 66. Rotational output (torque) from the motor 26 is received via output shaft 66 by the gearbox assembly 30, which then transfers the rotational output through a final drive gearset and the differential 38 to the axles 48, 52.

In the example implementation, the gearbox assembly 30 includes a planetary gearset 72, a gear reduction arrangement or final drive gearset 76, an actuator 80 and first and second torque transfer devices 84, 88. In one example implementation, the gearbox assembly 30 includes only the one or single planetary gearset 72 (without the ring gear), only the one actuator 80, and only the two torque transfer devices 84, 88. In such an example implementation, the actuator 80 can be an electro-mechanical actuator capable of controlling both two torque transfer devices 84, 88. The actuator 80 is in signal communication with and controlled by an electronic control module or controller 94, as will be discussed in greater detail below. In the example implementation, the first torque transfer device 84 is a controllable clutch and the second torque transfer device 88 is a controllable brake fixed to housing 42 or another suitable grounding structure. In the illustrated implementation, the clutch 84 and brake 88 are shown as back-to-back controllable synchronizers, but they could also be multi-plate clutches. It will also be appreciated that the clutch and brake 84, 88 may be any suitable type of clutch or synchronizer or torque transfer devices that enables gearbox assembly 30 to function as described herein.

In the example implementation, the planetary gearset 72 includes first and second sun gears 102, 106, a single carrier 110 and associated first and second planet gears or planetaries 114, 118, and does not include a ring or annulus gear. The single carrier 110 rotationally supports the first and second planetaries 114, 118 and is selectively groundable or connectable to the second sun gear 106 via control of clutch 80, as will be discussed in greater detail below. The first sun gear 102 is coupled for common rotation to the rotor output shaft 66 and is in meshing engagement with the first planetaries 114. The second sun gear 106 is in meshing engagement with the second planetaries 118 and is configured for selective coupling via the clutch 84 or the brake 88, as will also be discussed in greater detail below. An output of the planetary gearset 72 is coupled to the gear reduction arrangement or final drive gearset 76 at 126 via carrier 110.

The final drive gearset 76 can include, in one example implementation, four gears coupled via two parallel layshafts to transfer torque output from the planetary gearset 72 to the differential 38. In more detail, a first gear 132 is coupled to carrier 110 and is in meshing engagement with a second gear 136. Second gear 136 is coupled for common rotation with third gear 140 via layshaft 144. Third gear 140 is in meshing engagement with fourth gear 148, which is coupled to layshaft 150 and an input 152 of differential 38. In the example implementation illustrated, layshafts 144 and 150 are parallel to each other. It will be appreciated that while the above final drive gearset arrangement has been described, other gear set combinations and/or configurations are contemplated herein.

Using the EDM 14 to deliver drive torque from the electric motor 26, through the gearbox assembly 30, and to the drive wheels 18 will now be described in connection with operating modes of a first gear, a second gear and neutral. As used herein, “engage” or “activate” or “actuate” is used to mean closing a clutch or synchronizer or torque transfer device to transmit torque.

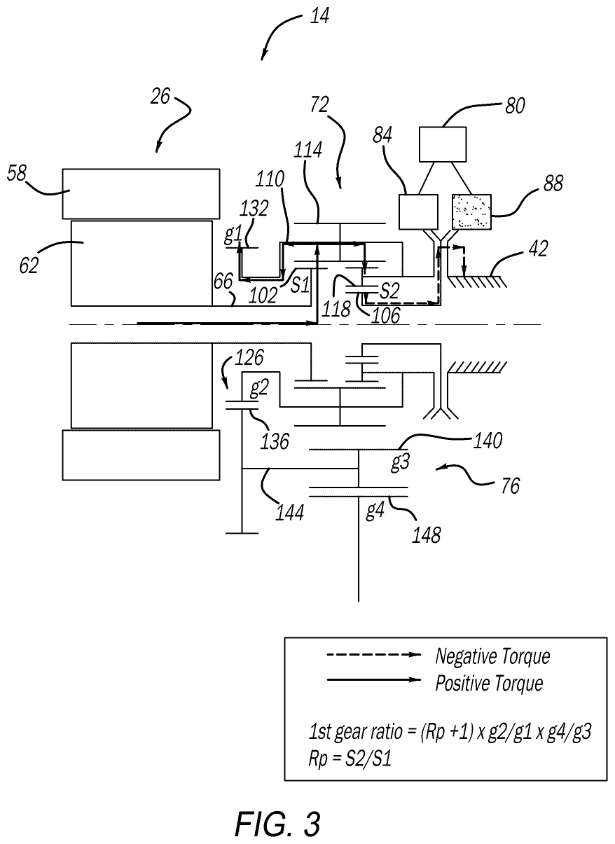

FIG. 3 illustrates the operating mode of first gear of EDM 14. In this operating mode, the controller 94 may receive a torque request or a gear change request from a vehicle input 96, such as an accelerator pedal or a high/low range switch, that would require the EDM 14 to be in a first gear configuration. For this first gear configuration, the controller 94 is configured to activate or engage brake 88 to ground the second sun gear 106, such as to housing 42. The clutch 80 is not activated and/or is open. Torque from electric motor 26 flows via rotor 62 and output shaft 66 to connected first sun gear 102 thereby rotationally driving first sun gear 102. First sun gear 102 drives the first and second planetaries 114, 118 and carrier 110 to drive first or input gear 132 of final drive gearset 76, with the grounded second sun gear 106 serving as a torque reaction element. This results in the carrier 110 rotating at a slower speed than the rotor output shaft 66 rotational input speed, thereby providing an underdrive condition or the first gear ratio. The first gear ratio corresponds to the first gear of operation for the EMD 14 and vehicle 10. The torque power flow then continues through the second, third and fourth gears 136, 140 and 148 of gearbox assembly 30 to differential 38 and then wheels 18 via driveline 22.

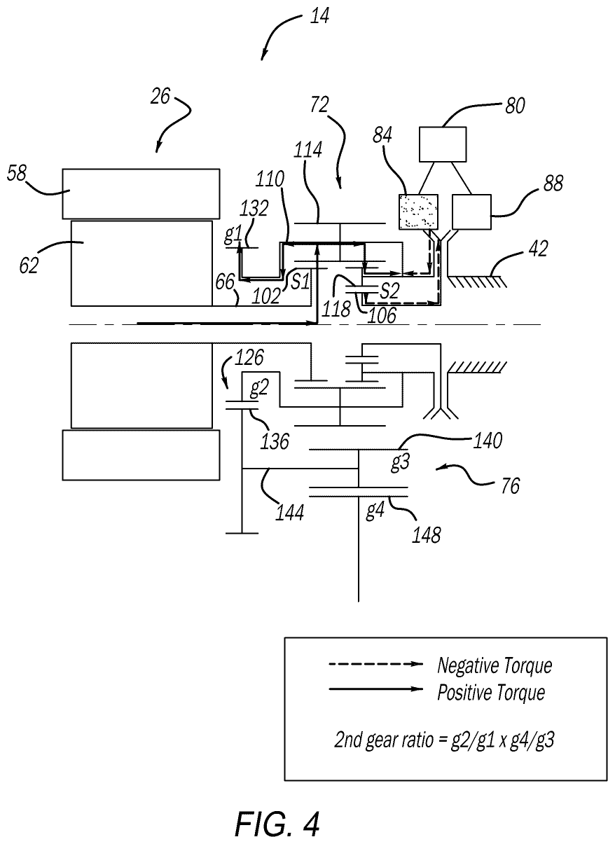

FIG. 4 illustrates the operating mode of second gear of EDM 14. For or in this operating mode, the controller 94 is configured to ground or connect the carrier 110 to the second sun gear 106 for common rotation via activation of clutch 84. The brake 88 is not activated and/or is open thereby providing for rotation of the second sun gear 106 relative to EDM housing 42. Activating clutch 80 essentially locks the first and second sun gears 102, 106 and second planet gears 118 together for common rotation with the rotor output shaft 66 thereby providing a second gear ratio (for the second gear configuration) and a direct drive configuration via activation of clutch 80. Torque output from motor 26 drives the first sun gear 102 via rotor shaft 66. Rotation of first sun gear 102 drives the first and second planetaries 114, 118, which results in driving the second sun gear 106, which drives carrier 110 via engaged clutch 84. Carrier 110 drives connected first gear 132 of the final drive gearset 76. The torque power flow then continues through the second, third and fourth gears 136, 140 and 148 of gearbox assembly 30 to differential 38 and then wheels 18 via driveline 22.

The EDM 14 also includes and provides the functionality of operating in a neutral state or mode where the motor 26 is disconnected from the drive gears. The neutral state or operating mode is provided by controlling the clutch and brake 84, 88 to be in an open or disengaged state. The neutral state can be particularly useful for flat towing a vehicle having EDM 14.

Described herein is an improved EDM 14 for an electrified vehicle that includes a two-speed gearbox utilizing a single planetary gearset, two torque transfer devices and a single actuator associated therewith. The single planetary gearset includes two sun gears, a single carrier rotationally supporting two planetary gearsets, and an absence of any ring or annulus gear. These features alone or in combination provide for a more efficient gearbox with improved NVH that can switch between the two gears and neutral via a single actuator all while being more compact due in part to the absence of the ring gear. Further, the design of EDM 14 advantageously does not require individual electric drive modules for each wheel or complex controls/mechanisms.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

It will be appreciated that the term “controller” or “control system” (as well as “module” and “unit”) as used herein refers to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Some portions of the above description may present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above. It will also be understood that the description, including disclosed examples and drawings, is merely exemplary in nature intended for purposes of illustration only and is not intended to limit the scope of the present disclosure, its application or uses. Thus, variations that do not depart from the gist of the present disclosure are intended to be within the scope of the present disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electric drive module (EDM) for an electrified vehicle, the EDM having a housing, an electric motor and a two-speed gearbox assembly, the two-speed gearbox assembly comprising:
a single planetary gear set including first and second sun gears, a single planetary carrier having first and second planetary gears in meshing engagement with the respective first and second sun gears, and an absence of a ring or annulus gear;
a first torque transfer device configured to be controlled to selectively couple the carrier to the second sun gear; and
a second torque transfer device fixed to the housing and configured for selective coupling the second sun gear to the housing;
wherein an output of the electric motor is connected to the first sun gear and the carrier is connected to a final drive gearset which is adapted to be coupled to a driveline of the vehicle; and
wherein the EDM is selectively switchable among (i) a first gear where the first torque transfer device is disengaged and the second torque transfer device is engaged grounding the second sun gear to the housing; and (ii) a second gear where the second torque transfer device is disengaged and the first torque transfer device is engaged to couple for common rotation the carrier and the second sun gear.

2. The EDM of claim 1, wherein the EDM is selectively switchable to a neutral state by controlling the first and second torque transfer devices to be disengaged or open.

3. The EDM of claim 1, wherein the first torque transfer device is a clutch and the second torque transfer device is a brake.

4. The EDM of claim 1, wherein the two-speed gearbox assembly comprises only one planetary gearset and only two torque transfer devices.

5. The EDM of claim 4, wherein the two-speed gearbox assembly further comprises an actuator for actuating both the first and second torque transfer devices.

6. The EDM of claim 5, wherein the EDM includes only one actuator for actuating both torque transfer devices.

7. The EDM of claim 1, wherein the final drive gearset comprises an input gear coupled to the carrier and an output gear adapted to be coupled to the driveline of the vehicle.

8. The EDM of claim 7, wherein the final drive gearset further comprises a second gear in meshing engagement with the input gear and coupled via a first layshaft to a third gear, which is in meshing engagement with a fourth gear, which is coupled to a second layshaft, which forms an output of the final drive gearset.

9. The EDM of claim 8, wherein the first and second layshafts have parallel longitudinal rotational axes.

10. An electrified vehicle, comprising:
an electric drive module (EDM) including:
a housing;
an electric motor; and
a two-speed gearbox assembly comprising:
a single planetary gear set including first and second sun gears, a single planetary carrier having first and second planetary gears in meshing engagement with the respective first and second sun gears, and an absence of a ring or annulus gear;
a first torque transfer device configured to be controlled to selectively couple the carrier to the second sun gear; and
a second torque transfer device fixed to the housing and configured for selective coupling the second sun gear to the housing;
wherein an output of the electric motor is connected to the first sun gear and the carrier is connected to a final drive gearset which is adapted to be coupled to a driveline of the vehicle; and
wherein the EDM is selectively switchable among (i) a first gear where the first torque transfer device is disengaged and the second torque transfer device is engaged grounding the second sun gear to the housing; and (ii) a second gear where the second torque transfer device is disengaged and the first torque transfer device is engaged to couple for common rotation the carrier and the second sun gear.

11. The vehicle of claim 10, wherein the EDM is selectively switchable to a neutral state by controlling the first and second torque transfer devices to be disengaged or open.

12. The vehicle of claim 10, wherein the first torque transfer device is a clutch and the second torque transfer device is a brake.

13. The vehicle of claim 10, wherein the two-speed gearbox assembly comprises only one planetary gearset and only two torque transfer devices.

14. The vehicle of claim 13, wherein the two-speed gearbox assembly further comprises an actuator for actuating both the first and second torque transfer devices.

15. The vehicle of claim 14, wherein the EDM includes only one actuator for actuating both torque transfer devices.

16. The vehicle of claim 10, wherein the final drive gearset comprises an input gear coupled to the carrier and an output gear adapted to be coupled to the driveline of the vehicle.

17. The vehicle of claim 16, wherein the final drive gearset further comprises a second gear in meshing engagement with the input gear and coupled via a first layshaft to a third gear, which is in meshing engagement with a fourth gear, which is coupled to a second layshaft, which forms an output of the final drive gearset.

18. The vehicle of claim 17, wherein the output of the final drive gearset forms an input to a differential of the driveline of the vehicle.

19. The EDM of claim 17, wherein the first and second layshafts have parallel longitudinal rotational axes.
